(19) United States
(12) Patent Application Publication
(10) Pub. No.: US 2002/0042747 A1
(43) Pub. Date: Apr. 11, 2002

(54) Automatic prompting for printer ink refill

(76) Inventor: Anthony F. Istvan, Snoqualmie, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/739,584

(22) Filed: Dec. 15, 2000

Related U.S. Application Data
(60) Provisional application No. 60/238,581, filed on Oct. 6, 2000.

(51) Int. Cl. G06F 17/60

(52) U.S. Cl. 705/26; 705/14; 705/27

(57) ABSTRACT

Embodiments of the present invention are directed to methods and systems of providing automatic prompting for printer ink refill of a printer connected to a communication device. A printer monitoring component is configured to monitor the printer for an ink refill signal. A user notification component within the communication device is configured to automatically notify a user of the communication device in response to receipt of the ink refill signal. In some embodiments, an information retrieval component is configured to retrieve ink refill information for the printer. An information delivery component is configured to deliver the retrieved information to the communication device in response to receipt of the ink refill signal. A communication channel reservation component is configured to reserve a communication channel for delivery of information to the communication device. An on-line shopping component is configured to facilitate on-line shopping of one or more ink refill products on the Internet. A user customization component is configured to receive a user selection of a notification format for delivery of the information.

### RELATED APPLICATIONS

The present application is related to and claims priority from provisional application No. 60/238,581, entitled “User Interface, System, and Method for Personalized Access to Internet-Enabled TV,” filed Oct. 6, 2000, with inventors Paul G. Allen, Anthony F. Istvan, and Armando P. Stettner, which is incorporated herein by reference in its entirety.

### FIELD OF THE INVENTION

The present application relates generally to communications systems including interactive television systems, computer systems, and the like. More particularly, the application relates to systems and methods of providing automatic prompting for printer refill associated with the communication systems.

### BACKGROUND

Televisions and Internet technologies are beginning to converge. In particular, access to the World Wide Web via an Internet-enabled television system is progressing and becoming more popular. This access can be provided to the user through an interactive television, a personal computer, or other communication devices.

A printer can be connected to the communication device such as an interactive television for printing images from the communication device. Currently, laser printers and ink-jet printers are commonly used. The toner or ink jet refill cartridges need to be replaced when the toner or ink level is low. As used herein, the term ink refill is used to refer to ink or toner refill for a printer. The logistics of identifying and ordering the correct cartridge can be cumbersome and time-consuming.

### SUMMARY

Embodiments of the present invention provide automatic prompting to the user when a printer refill is needed, and present the user with information to help the user identify and order the printer refill product that is needed. For instance, the user may be directed to an on-line shopping website that allows the user to obtain product, pricing, and shipping information and to make an on-line purchase. The user's wallet information including credit card information and shipping address may be stored and then automatically retrieved for convenient and quick on-line purchases. The user will not need to look for and enter such data. The purchase of refill cartridges is user-friendly, quick, convenient, and easy. The automatic prompting scheme can be used in a variety of environments, including a system for distributing multimedia content to Internet-enable televisions or similar communication devices, as well as a computer system such as a networked personal computer system.

In accordance with an aspect of the present invention, a method of providing automatic prompting for printer ink refill of a printer connected to a communication device comprises monitoring the printer for an ink refill signal, and automatically delivering a user notification to a user of the communication device connected to the printer upon receiving the ink refill signal associated with the printer.

In some embodiments, the method further comprises identifying the printer model and ink refill product for the printer. In a specific embodiment, the printer model is identified from the printer driver in the communication device. The ink refill product for the printer is identified by accessing an ink refill product identification source. The method may include retrieving information for the ink refill product for the printer from an information source and delivering the retrieved information to the communication device connected to the printer.

The method may include facilitating an order for the ink refill product by a user via the communication device, for instance, by launching a web browser to provide on-line shopping to the user of the communication device. The information may be delivered to the communication device using a default format or using a format selected by a user of the communication device. The format may be selected from alerts, always-active formats, button-press-required formats, e-mail notifications, and the like.

In specific embodiments, the communication device comprises an Internet-enabled television system. The Internet-enabled television system provides a graphical user interface. The user notification may be displayed in a designated area of the graphical user interface, or superimposed over a television program displayed by the Internet-enabled television system. Alternatively, the user notification may be delivered by sending an e-mail message to a user of the communication device.

In some embodiments, the communication device comprises a computer device, or a network server in a computer network system.

In accordance with another aspect of the present invention, a system of providing automatic prompting for printer ink refill of a printer connected to a communication device comprises a printer monitoring component configured to monitor the printer for an ink refill signal. A user notification component within the communication device is configured to automatically notify a user of the communication device in response to receipt of the ink refill signal.

In some embodiments, an information retrieval component is configured to retrieve ink refill information for the printer. An information delivery component is configured to deliver the retrieved information to the communication device in response to receipt of the ink refill signal. A communication channel reservation component is configured to reserve a communication channel for delivery of information to the communication device. An on-line shopping component is configured to facilitate on-line shopping of one or more ink refill products on the Internet. A user customization component is configured to receive a user selection of a notification format for delivery of the information.

### BRIEF DESCRIPTION OF THE DRAWINGS

FIG. 1 is a schematic diagram depicting a system 100 for distributing multimedia content to Internet-enabled televisions in accordance with an embodiment of the present invention.

FIG. 2 is an illustrative screen frame of a display with a full-size video being displayed.

FIG. 3 depicts an example layout 300 of a user interface (UI) which has been activated in accordance with an embodiment of the present invention.

FIG. 4 is an illustrative screen frame of a UI which has been activated in accordance with an embodiment of the present invention.

FIG. 5 depicts an example layout 500 of a UI with a user submenu activated in accordance with an embodiment of the present invention.

FIG. 6 depicts an example layout 600 of a UI with a TV submenu 602 activated in accordance with an embodiment of the present invention.

FIG. 7 depicts an example layout 700 of a UI with television listing controls in the context-sensitive area 304 in accordance with an embodiment of the present invention.

FIG. 8 is an illustrative screen frame of a UI in a TV listing mode which provides an electronic programming guide (EPG) in accordance with an embodiment of the present invention.

FIG. 9 depicts an example layout 900 of a UI with a browser submenu 902 activated in accordance with an embodiment of the present invention.

FIG. 10 depicts an example layout 1000 of a UI with browser controls in the context-sensitive area 304 in accordance with an embodiment of the present invention.

FIG. 11 is an illustrative design for a remote control 1100 in accordance with an embodiment of the present invention.

FIG. 12 is a schematic diagram depicting a printer 1202 connected to a set top box 108 in the system 100 of FIG. 1 in accordance with an embodiment of the present invention.

FIG. 13 is a schematic diagram of a system 1300 for printer monitoring and low-ink level notification with information retrieval and delivery in accordance with an embodiment of the present invention.

FIG. 14 depicts a notification format menu in accordance with an embodiment of the present invention.

FIG. 15 is a flowchart of a method for low-ink level notification and information retrieval and delivery in accordance with an embodiment of the present invention.

### DESCRIPTION OF THE SPECIFIC EMBODIMENTS

Embodiments of the present invention provide automatic prompting for printer refill upon detection of a low-ink level signal from a printer in a system. Features of the invention are described in the context of a system for distributing multimedia content to Internet-enable televisions or similar communication devices. It is understood, however, that the invention can be employed for monitoring printers in other systems including, for example, networked computer systems.

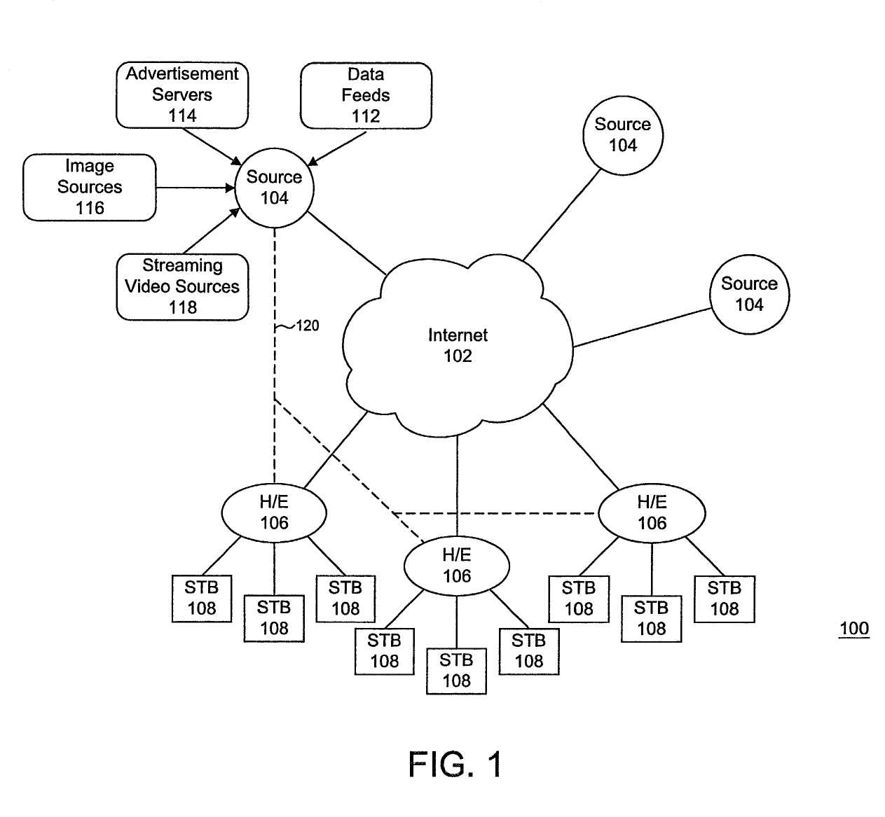

FIG. 1 is a schematic diagram depicting a system 100 for distributing Internet content, in addition to TV content, in accordance with an embodiment of the present invention. In accordance with an embodiment of the present invention, the system 100 is integrated with a cable TV distribution system. Such cable TV distribution systems may include cable headends and are well known in the art.

The system 100 includes an Internet 102, a plurality of content sources 104, a plurality of distribution centers (depicted as headends or H/E) 106, and a plurality of client terminals (depicted as set top boxes or STB) 108. In addition, a content source 104 is depicted as receiving data from data feeds 112, advertisement servers 114, image sources 116, and streaming video sources 118.

The plurality of content sources 104 are coupled to the Internet 102. For example, a content source 104 may comprise a web site portal such as Go2Net.com, or a news web site such as CNN.com, or other types of sources. Each content source 104 may have various data feeds 112, servers 114, and sources 116/118 coupled to it.

For example, news or stock quote feeds 112 may be fed into the content source 104. Servers 114 may provide advertisements for insertion into multimedia content delivered by the content source 104. Sources 116/118 may provide images 116, streaming video 118, and other content to the content source 104. Various other feeds, servers and sources may also be coupled to the content source 104.

The Internet 102 comprises a network of networks and is well known in the art. Communications over the Internet 102 are accomplished using standard protocols such as TCP/IP (transmission control protocol/internet protocol) and other protocols. The Internet 102 is coupled to the plurality of distribution centers 106. For example, a distribution center 106 may comprise a cable headend (H/E).

Each distribution center 106 is coupled to a plurality of client terminals 108. For example, a client terminal 108 may comprise a set top box (STB), a personal computer, an interactive television set, or another type of communication device.

In alternative or in addition to the Internet 102 being used to distribute multimedia content from the content sources 104 to distribution centers 106, communications channels or networks 120 apart from the Internet 102 may couple one or more content source 104 to one or more distribution center 106. One example of such an alternate path for communications is illustrated in FIG. 1. Other configurations are also possible and meant to be included within the scope of the present invention.

Embodiments of the present invention may utilize other distribution or communications systems besides the one described above in relation to FIG. 1. Instead of a cable distribution system, other systems that may be used include telephone, ISDN, digital subscriber line (DSL), satellite, and other communications systems. The distribution or communications system may comprise a private network or a “walled garden” network.

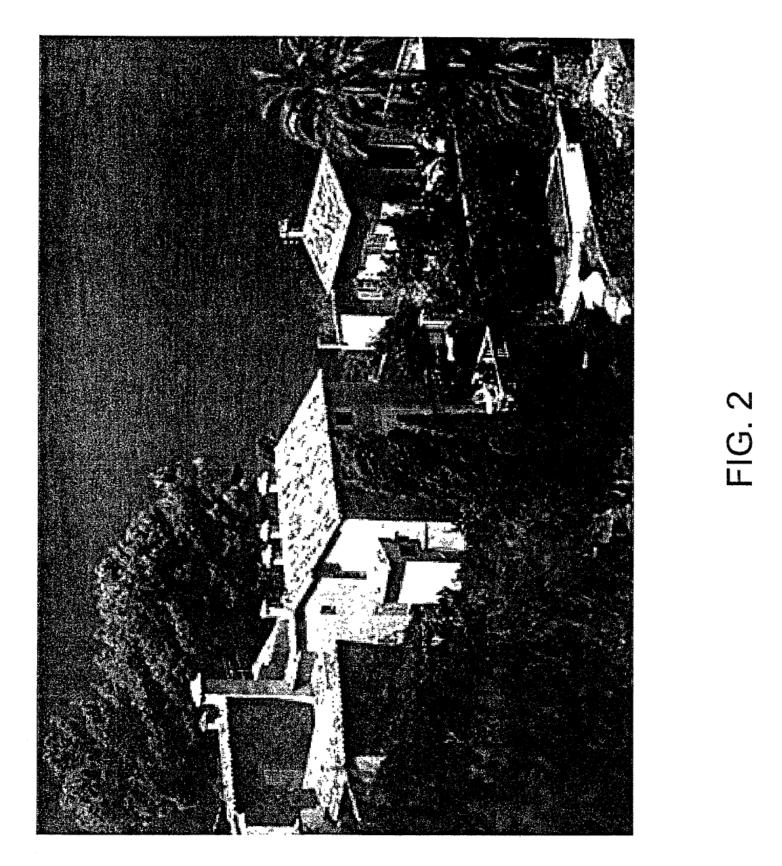

FIG. 2 is an illustrative screen frame of a display with a full-size video being displayed. While the screen frame is a still frame, the actual video is a motion video comprising a multitude of frames in sequence.

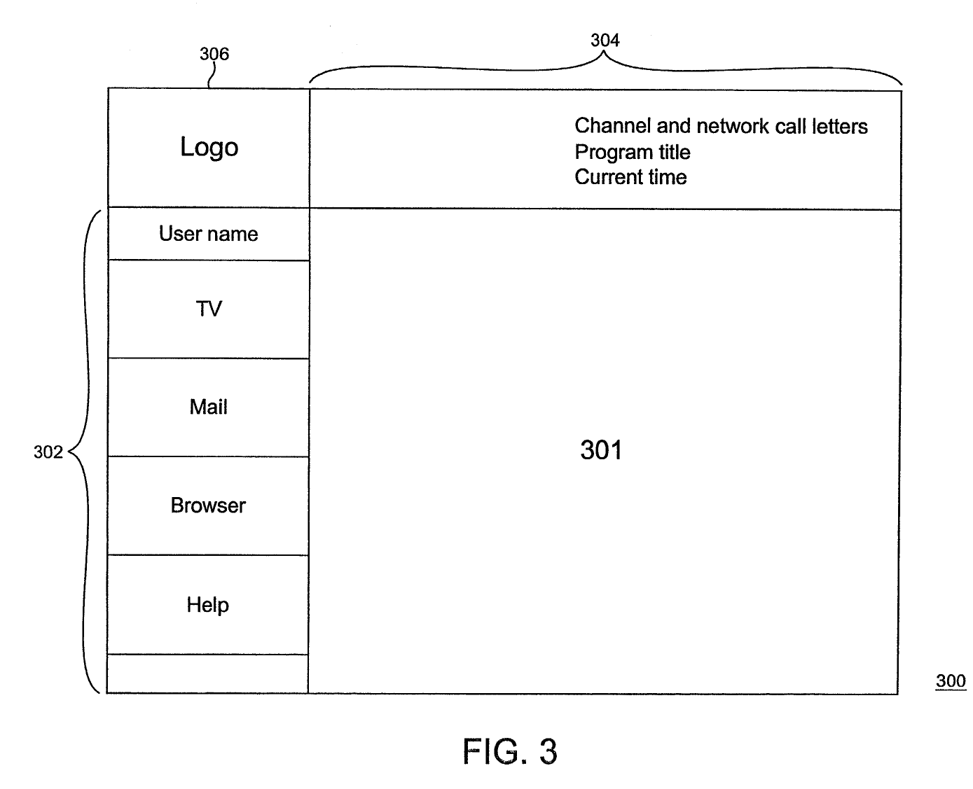

FIG. 3 depicts an example layout 300 of a user interface (UI) which has been activated in accordance with an embodiment of the present invention. In one embodiment, when the UI is activated, the full-size display (see FIG. 2) shrinks in an “animated” fashion (i.e. with visible motion to a viewer) to occupy a reduced-size area 301 of the display. Alternatively, when the UI is activated, the L configured UI may be superimposed (overlaid) over the full-size display. For example, shrinking the full-size display may be used if the display is showing TV or video content, while superimposing over the full-size display may be used if the display is showing pages which do not scale well. A “menu” button on a remote control unit may be used to activate and deactivate the UI.

The UI includes a group of permanent or primary controls 302 on a first side of the reduced-size area 301, a context-sensitive area 304 on a second side of the reduced-size area 301 (perpendicular to the first side), and a logo area 306 at the intersection of the two sides. In the example layout 300 shown in FIG. 3, the primary controls 302 include user (“user name”), TV, mail, browser, and help controls or control icons.

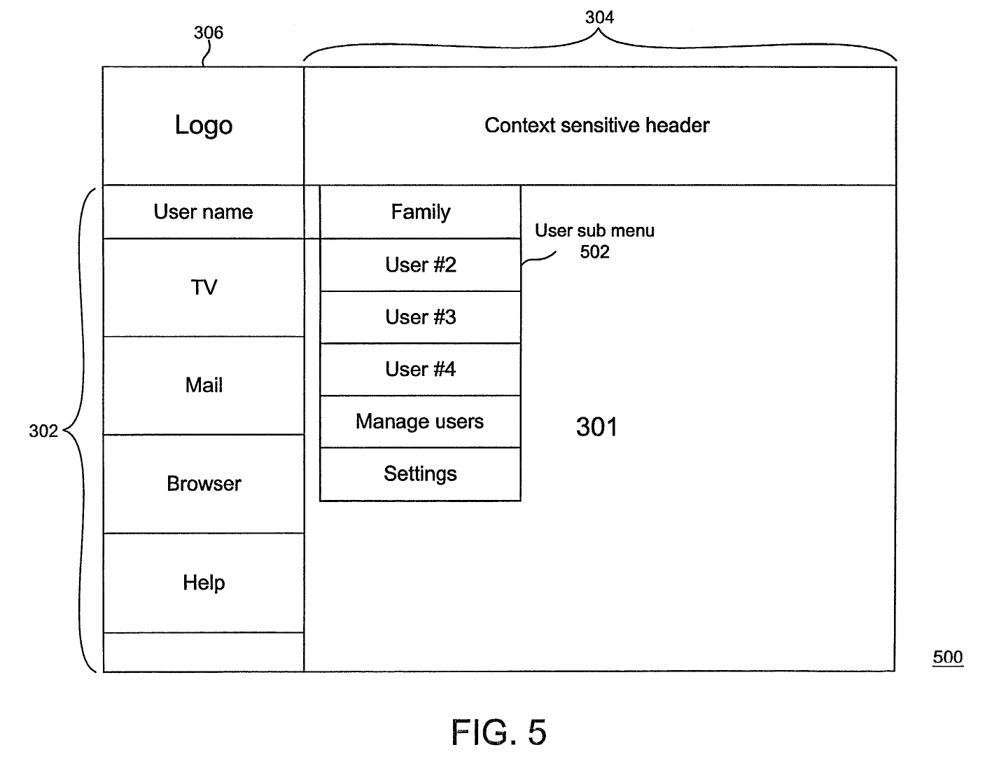

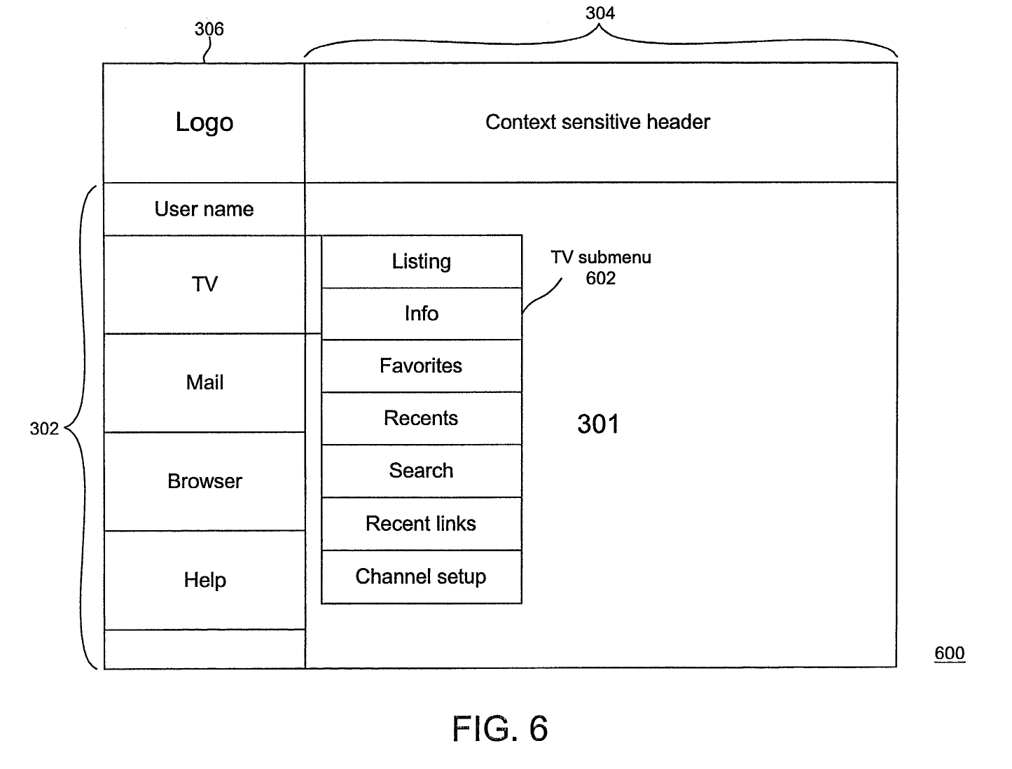

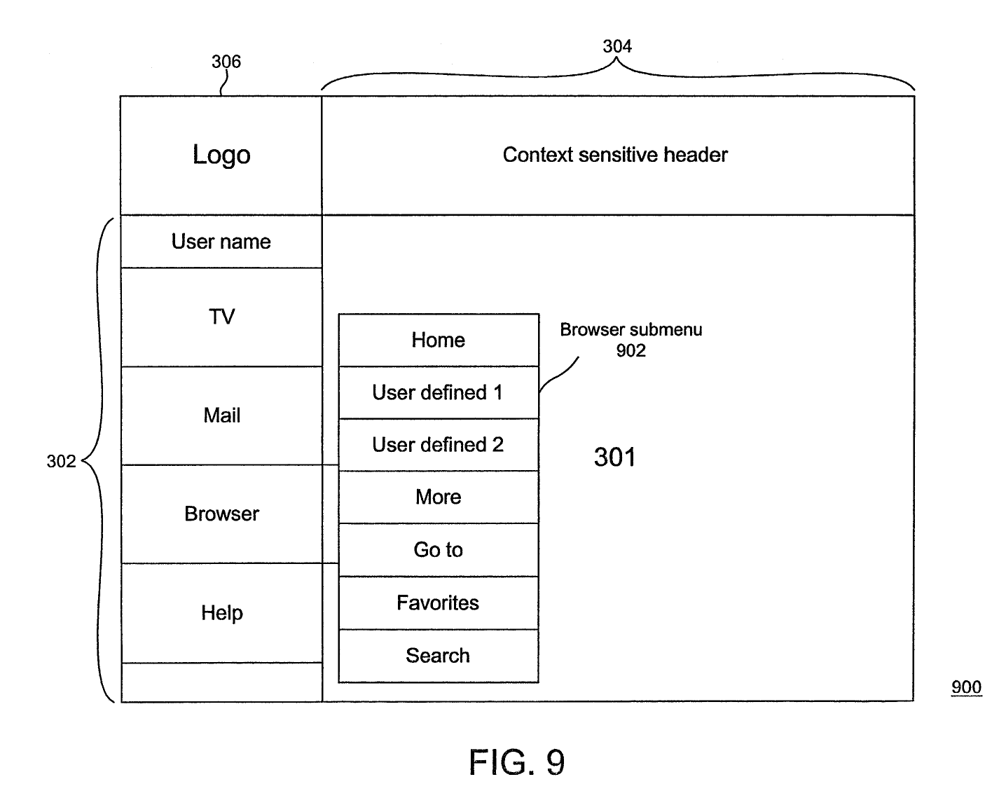

Selection of these primary control icons typically reveals a corresponding submenu. For purposes of illustration, described in detail below are a selection of such submenus. First, an example of a user submenu 502 is described below in relation to FIG. 5. Second, an example of the TV submenu 602 is described below in relation to FIG. 6. Third, an example of a browser submenu 902 is described below in relation to FIG. 9.

The context-sensitive area 304 may display different information (non-selectable items) and control icons (selectable items) depending upon the content in the display area 301. Initially, the context-sensitive area 304 may display information on the TV content currently being displayed in the display area 301. The information may include, for example, channel number/network call letters, program title, and current time.

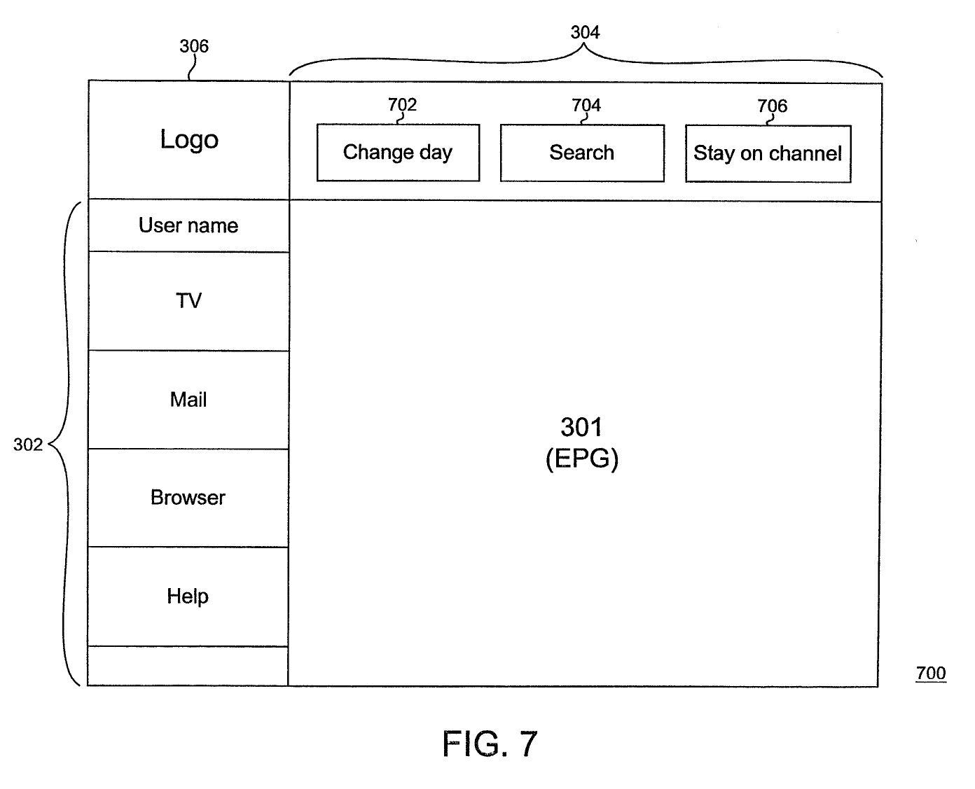

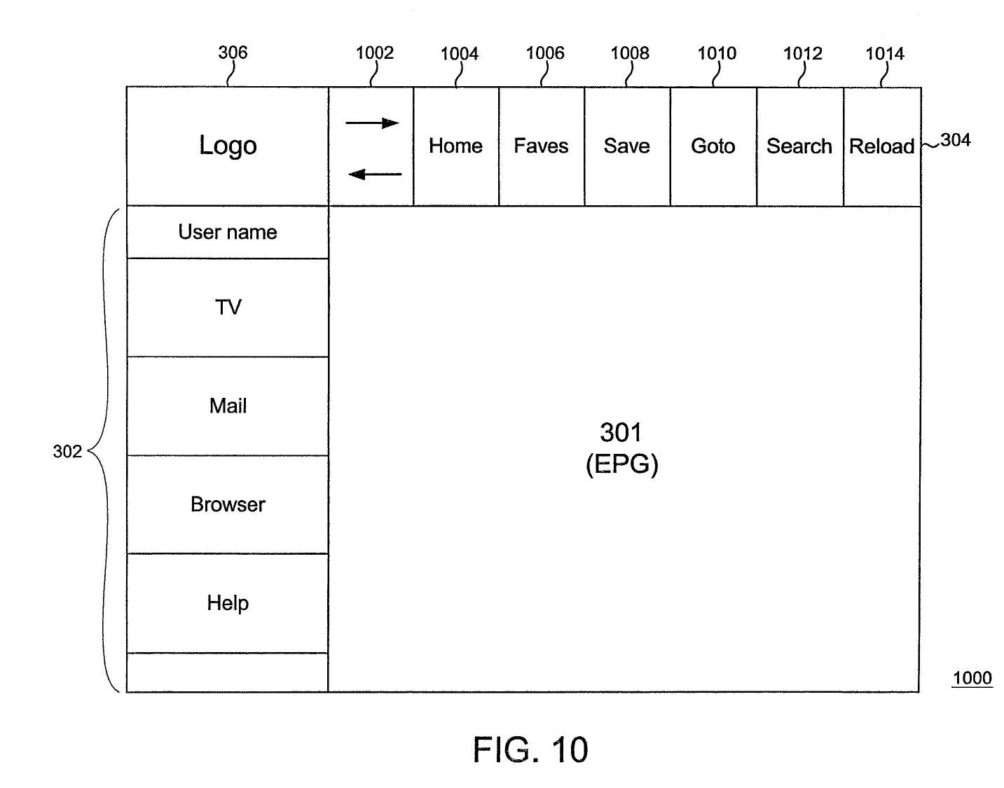

As the content in the display area 301 varies, so will the information and control icons in the context-sensitive area 304. For example, first, when display area 301 contains TV content, then context-sensitive area 304 may have the information shown in FIG. 3. Second, when the display area 301 contains electronic programming guide (EPG) content, then context-sensitive area 304 may have the controls described in relation to FIG. 7. Third, when display area 301 contains web content, then context-sensitive area 304 may have the controls described in relation to FIG. 10.

The logo area 306 may display, for example, a logo and name for a service provider. In this example, the service provider is named Charter Communications™.

While the particular layout of FIG. 3 shows a “L” configured UI along the top and left sides of the display, other “L” configurations are also contemplated and within the scope of the present invention. For example, the “L” configured UI may instead be along the bottom and left sides, or the bottom and right sides, or the top and right sides.

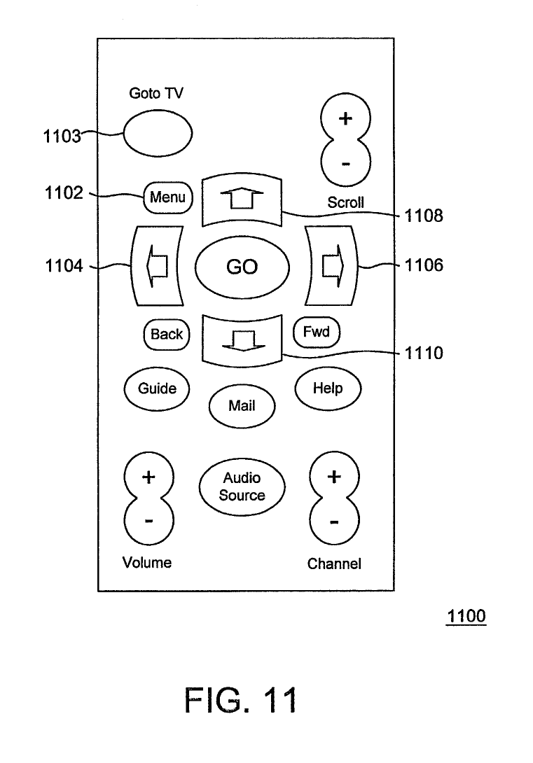

In accordance with an embodiment of the present invention, a first pair of arrows on a remote control navigates among the primary controls, and a second pair of arrows (perpendicular to the first pair) navigates among the context-sensitive controls. Switching between navigation among the primary controls and navigation among the context-sensitive controls occurs automatically upon switching between using the first pair of arrows and using the second pair of arrows. An example of a remote control with such arrows is shown in FIG. 11 which is described below.

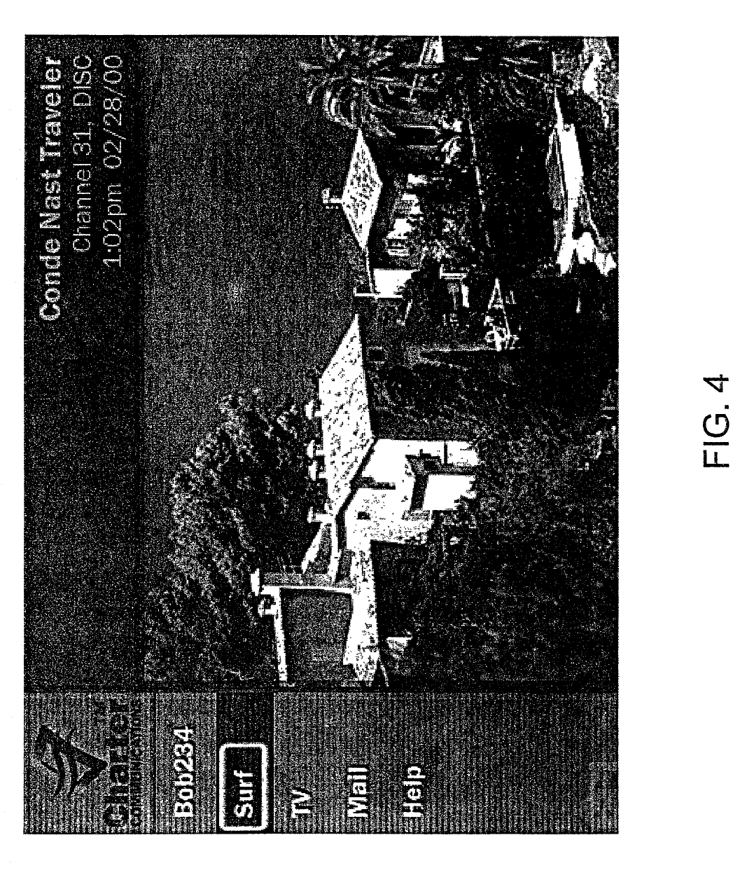

FIG. 4 is an illustrative screen frame of a UI which has been activated in accordance with an embodiment of the present invention. The frame shown in FIG. 4 is an implementation in close (but not exact) correspondence to the layout 300 of FIG. 3. Like the layout 300 in FIG. 3, the UI of FIG. 4 has primary controls on the left side, a context-sensitive area on the top, and a service provider's logo at the upper left corner.

Regarding the primary controls, “Bob234” is an example name of a currently active user. The “Surf” control corresponds to the browser control. Regarding the context-sensitive area, “Conde Nast Traveler” corresponds to the program title. “Channel 31, DSC” corresponds to the channel/network call letters. And, finally, “1:02 pm Feb. 28, 2000” corresponds to the current time (and date).

FIG. 5 depicts an example layout 500 of an UI with a user submenu 502 activated in accordance with an embodiment of the present invention. The user submenu 502 is activated by selecting the “user name” on-screen control from the group of primary controls 302. The user submenu 502 may include various selections.

The “family” user is the default selection when the UI is activated. In one embodiment, the family user will be able to access only content which is accessible to all other users. In other words, the family user will have a “permission space” which is the intersection of permission spaces of all other users. Advantageously, this feature does not require a password to be entered upon turning on the TV. Nevertheless, this feature may be used to prevent children from accessing excessively violent or adult-oriented content. Moreover, the protection provided may extend to both TV and Internet content.

User #2, user #3, . . . , user #N, may be individual user names, each of which may have a password to protect against entry by an unauthorized person. For example, the different users may correspond to members of a family. These user names may be sorted alphabetically in the user submenu 502. When an individual user name is selected and password, if any, entered correctly, then the user name becomes the active user.

The “manage users” and “settings” selections may be used to perform such function as: editing user name, password, and other user-related information for a specified user account; allowing users to block certain emails; allowing a user with administrative privileges to add or remove users and change user privileges; and so on.

FIG. 6 depicts an example layout 600 of a UI with a TV submenu 602 activated in accordance with an embodiment of the present invention. The TV submenu 602 is activated by selecting the “tv” on-screen control from the group of primary controls 302. The TV submenu 602 may include various selections.

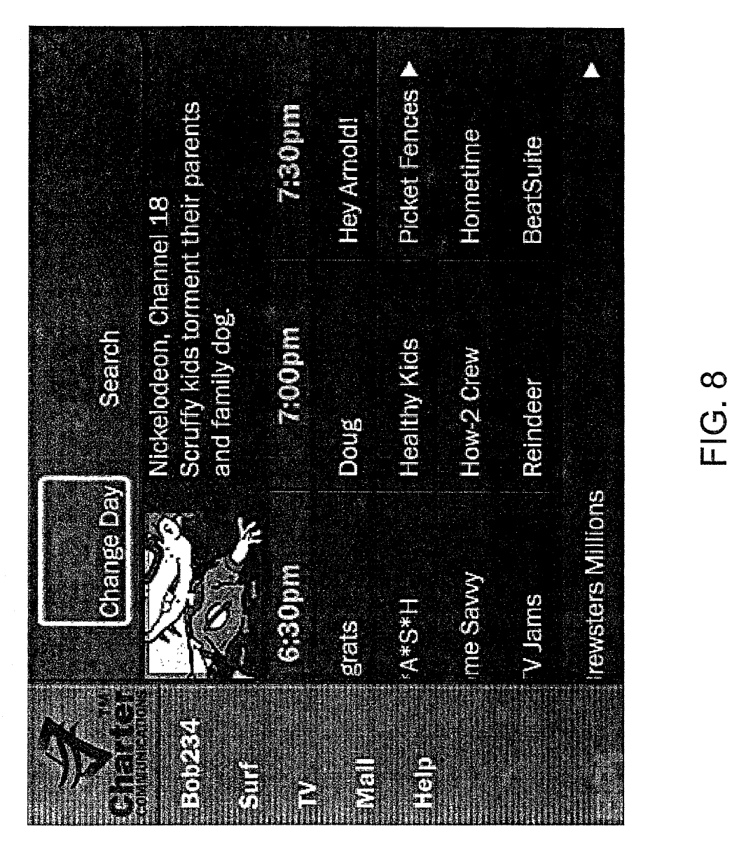

The “listing” selection provides an electronic programming guide (EPG) to broadcast TV content. When the EPG is provide, corresponding controls are provided in the context-sensitive area 304 as described below in relation to FIG. 7. An example of such an EPG within the UI is illustrated in FIG. 8 which is also described below.

The “info” selection provides information relating to the TV program currently being viewed in the display area 301. The information may include a brief description of the program, names of actors/actresses, copyright year, and so on.

The TV “favorites” selection provides a user with a list of his/her favorite TV channels. When a TV channel is selected from the favorite list, then the embedded TV display changes to that channel.

The TV “recents” selection provides small screen video images of the last N (where N is a positive integer) TV channels viewed. For example, if N=9, then video images of the 9 most recently viewed TV channels may be shown in a 3×3 matrix configuration in the embedded display 301. The number N may be fixed, or it may be user selectable.

The TV “search” selection provides a mechanism to search electronic program guide (EPG) listings for a particular program or programs. The search may be by program title, type of program (e.g., “basketball” may be searched to find basketball games being broadcast), by actor/actress, and so on.

These and other selections may be provided in the TV submenu 602. For example, “recent links” and “channel setup” selections are depicted in the TV submenu 602 of FIG. 6. The “recent links” selection provides access to hyperlinks recently received via a mechanism such as an ATVEF (Advanced TV Enhancement Forum) trigger. ATVEF is a cross-industry alliance of companies from broadcast and cable networks, television transport, consumer electronics, and personal computer industries. The “channel setup” selection allows a user to specify which TV channels are included as channels to tune to as part of the channel up/down tuning sequence.

FIG. 7 depicts an example layout 700 of a UI with television listing controls in the context-sensitive area 304 in accordance with an embodiment of the present invention. The television listing controls are provide when the display area 301 is used to provide an electronic programming guide (EPG).

The television listing controls shown in FIG. 7 include a “change day” control, an EPG “search” control, and a “stay on channel” control. The “change day” control allows the user to change the day of the program grid being shown by the EPG. The EPG “search” control provides access to a mechanism to search EPG listings for a particular program or programs. The “stay on channel” control comprises a toggle control to activate/deactivate this option. When the option is deactivated, then the TV tuner actively tunes to the selected channel in the program grid of the EPG. When the option is activated, then the TV tuner remains on the channel that was being displayed before entering the EPG.

FIG. 8 is an illustrative screen frame of a UI in a TV listing mode which provides an electronic programming guide (EPG) in accordance with an embodiment of the present invention. The frame shown in FIG. 8 is an implementation in close (but not exact) correspondence to the layout 700 of FIG. 7. (The frame of FIG. 8, for example, does not show a “stay on channel” toggle control.) The EPG shown provides a programming grid including rows representing different channels, and columns representing different timeslots. Other implementations of an EPG are also possible.

FIG. 9 depicts an example layout 900 of a UI with a browser submenu 902 activated in accordance with an embodiment of the present invention. The browser submenu 902 is activated by selecting the “browser” on-screen control from the group of primary controls 302. The browser submenu 902 may include various selections.

The “home” selection may provide access to a web page designated by a service provider (e.g., a MSO) as its “home” page. In one embodiment, when going to the home page, the L configured UI retracts, so that the home page is shown on a full-size screen.

The “user defined” selections provide access to specialized web pages which may be focused to various categories of content. For example, the specialized web pages may focus on categories such as news, money, sports, weather, entertainment, and others. Again, in one embodiment, when going to a specialized web page, the L configured UI retracts, so that the specialized page is shown on a full-size screen.

These and other selections may be provided in the browser submenu 902. For example, “more,” “go to,” browser “favorites,” and browser “search” selections are depicted in the browser submenu 902 shown in FIG. 9. The “more” button provides access to other categories of content in addition to those specified by the “user defined” selections described above. The “go to” button provides a query text box which allows a user to specify a URL to be displayed in the browser. The browser “favorites” button provides access to an organized data structure of favorite links. These browser favorites may be provided separately from the TV favorites, or they may be provided together in an integrated data structure. The browser “search” control provides access to a mechanism to search for particular Internet or Web content. The browser search may be provided separately from the EPG search, or they may be provided together in an integrated search feature.

FIG. 10 depicts an example layout 1000 of a UI with browser controls in the context-sensitive area 304 in accordance with an embodiment of the present invention. The browser controls are provided when the display area 301 is used to access World Wide Web content and other similar hyper linked content.

In the embodiment shown in FIG. 10, the left and right arrows 1002 may be individually selected. The left arrow scrolls or shifts the browser controls one button to the left. For example, in FIG. 10, the left arrow would cause the “home” button 1004 to scroll “behind” the arrows 1002 and a control button (not shown) to the right of the “reload” button 1014 to become visible at the right side of the context-sensitive area 304. Similarly, the right arrow scrolls or shifts the browser controls one button to the right.

In the embodiment shown in FIG. 10, the “home” button 1004 provides access to the web page designated by the user as his/her “home” page. The “faves” or favorites button 1006 provides access to a list of web pages or URLs that the user selects as his/her favorites. The “save” button 1008 enables a user to save a web page currently being displayed as a favorite page. The “go to” button 1010 provides a query text box which allows a user to specify a URL to be displayed in the browser. The “search” button 1012 provides access to a mechanism to search for particular Internet or Web content. The “reload” button 1014 causes the content currently in the display 301 to be refreshed.

Other buttons may be provided to the right of the “reload” button 1014. In one embodiment, the other buttons may include a “print” button, a “find” button, a “send” button, and an “info” button. The “print” button provides for printing, with various options, of the web page being displayed. The “find” button provides for finding a specified text string within the web page being displayed. The “send” button provides for sending an email with the web page being displayed or its URL attached thereto or contained therein. Finally, the “info” button provides additional information about the web page being displayed.

FIG. 11 is an illustrative design for a remote control 1100 in accordance with an embodiment of the present invention. Many other designs with similar functionality are, of course, possible and would be within the scope of the present invention.

The menu button 1102 may be used to activate and deactivate the UI as described above in relation to FIG. 3. The “Go To TV” button 1103 returns the display to a full-screen television display as illustrated by FIG. 2.

The up arrow 1108 and down arrow 1110 may be used to navigate among the primary controls 302. The left arrow 1104 and right arrow 1106 may be used to navigate among controls in the context-sensitive area 304. Switching between navigation among the primary controls and navigation among the context-sensitive controls occurs automatically upon switching between using the up/down arrows 1108/1110 and using the left/right arrows 1104/1106. The “Go” button (which may also be designated the “OK” button) activates the screen object currently selected (and highlighted), triggering an action associated with the object.

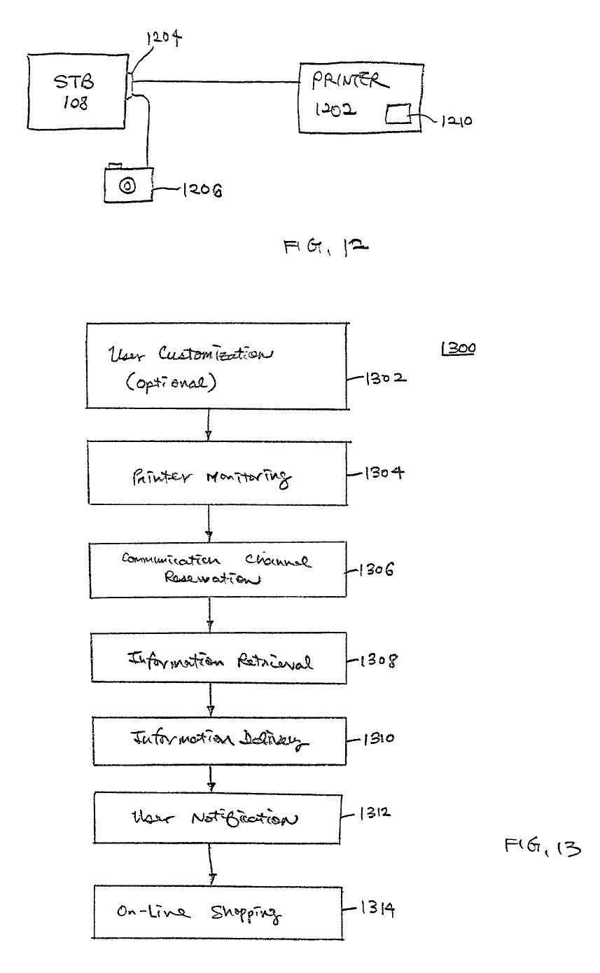

FIG. 12 shows a printer 1202 connected to an STB 108 in the system 100 of FIG. 1 for printing from the STB 108. The STB 108 may include a universal serial bus (USB) port 1204 or another type of port for receiving a cable to connect with the printer 1202. In a specific embodiment, the printer 1202 can be used to print images from a digital camera 1206 which is connected to the STB 108. The printer 1202 includes a sensor 1210 which monitors the ink or toner level of the printer 1202 and generates a low-ink signal when the ink or toner falls below a predetermined minimum level. An aspect of the invention is directed to notifying the user of the low-ink status, providing certain information to the user, and presenting the user with a convenient way to order a replacement cartridge or other printer ink refill products.

According to an embodiment of the invention, a printer monitoring and notification system 1300 as depicted in FIG. 13 receives the low-ink signal from the sensor 1210 and provides notification to the user. In various embodiments, the system 1300 includes a user customization component 1302, a printer monitoring component 1304, a communication channel reservation component 1306, an information retrieval component 1308, an information delivery component 1310, a user notification component 1312, and optionally an on-line shopping component 1314.

The user customization component 1320 may be an optional component that allows the user to customize certain information retrieval, delivery, and notification features as desired to replace the default settings. For instance, the system 1300 may have default settings for the information to be retrieved upon detection of a low-ink level signal, the information to be delivered to the user, and the notification format. The information to be retrieved may include, for example, the cartridge model(s) for the printer 1202, the on-line suppliers with pricing and ordering information, and the user's wallet information including credit card number, shipping information, and the like. The printer information can be obtained from the printer 1202. For example, the STB 108 connected to the printer 1202 includes the printer driver or other communication mechanism from which information on the printer type and model may be retrieved. The suitable cartridge model can be identified, for instance, from the printer 1202 or from another source 104 based on the printer information. The on-line information may be retrieved using the interactive system 100 of FIG. 1. The wallet information may be stored, for example, in the STB 108, a smartcard for use with the STB 108, or a server accessible via the interactive system 100. All or part of the retrieved information may be bundled with the low-ink level notification message and delivered to the user according to the notification format. The optional user customization component 1320 will allow the user to specify and customize those settings in place of the default settings to suit the user's needs and preferences.

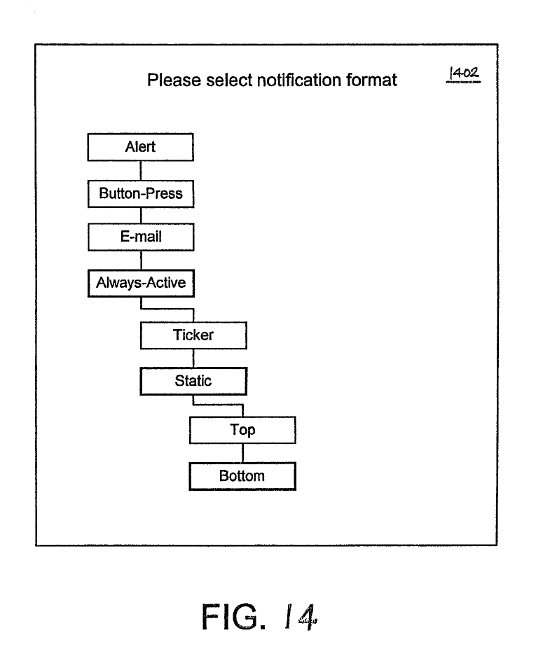

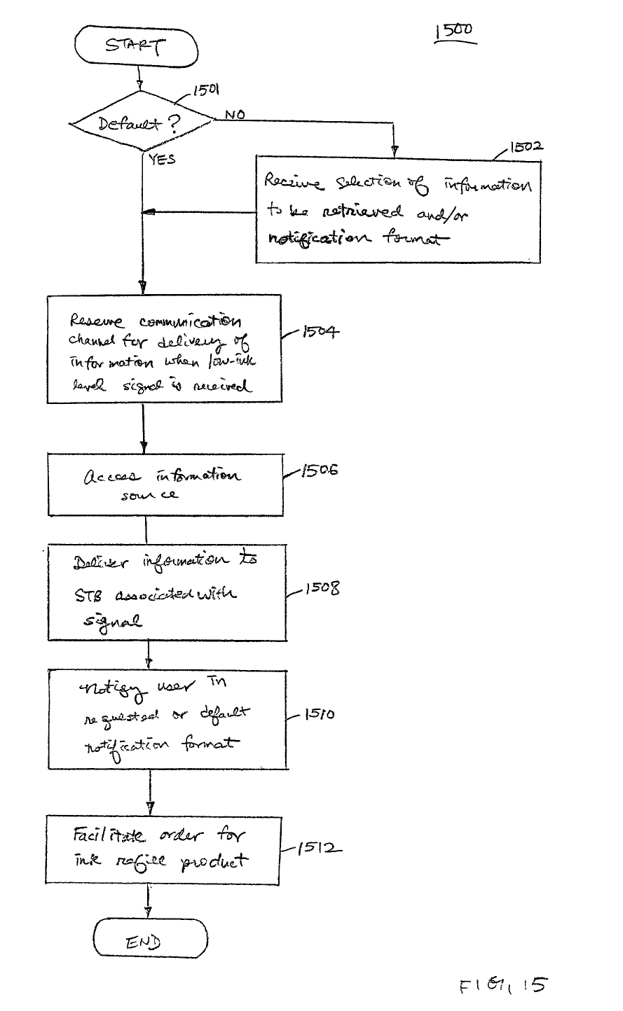

In one embodiment, the user customization component 1320 provides a notification format menu 1402, as shown in FIG. 14, by which the user may indicate the manner in which the user wishes to be notified of the low-ink status. Various notification formats may include, for example, alerts, always-active formats, button-press-required formats, e-mail notifications, and the like.

Alerts may include any type of textual, audio and/or video notification that includes the requested or retrieved information or a portion thereof. For instance, an alert may include a pop-up text message, video clip, audio clip, or the like. In various embodiments, the user may customize the alert using the menu 1402 to make the alert as overt or unobtrusive as the user desires.

Always-active formats may take the form of a transparent overlay of text, graphics, or the like, superimposed over the program being displayed on the television. The transparent overlay may be situated at the bottom, top, or user-selected location of the television. In the case of a text message, the message may be static or horizontally scrolling (e.g., a ticker).

In the button-press-required format, the monitored information is not immediately displayed upon the occurrence of the triggering event. Rather, after receiving a visually perceptible or audible notification, such as an icon, tone, tune, etc., the user must perform a subsequent action, such as pushing a button or the like on a remote control, in order to display the requested or retrieved information.

Of course, the notification formats are not limited to those discussed above. Other formats may include, for instance, email notification to the user, email notification to a different user, launching of a web browser configured to display the requested or retrieved information from a particular website, or displaying the information on a remote control equipped with a display device, such as an integrated LCD screen. A web browser may be launched, for example, to provide on-line shopping of a replacement cartridge for the user and allow the user to compare pricing and product information, and select the supplier, product, shipping, and the like.

After the user has selected the information to be retrieved and the notification format (collectively, the “user customized information”), the user customization component 1302 preferably stores the user customized information. In one embodiment, the user customized information is stored at a headend 106, content source 104, or other suitable location within the system 100.

Those skilled in the art will recognize that the user customization component 1302 may be embodied as hardware, software, and/or firmware within a headend 106, a content source 104, the STB 108, and/or a computer within the Internet 102.

In one embodiment, after the delivery criteria have been satisfied upon receipt of a low-ink level signal by the printer monitoring component 1304, the communication channel reservation component 1306 reserves network resources to enable delivery of the information retrieved via the interactive system 100 to the STB 108 once the delivery criteria are satisfied (i.e., the low-ink level signal is received). In the context of a cable delivery network, reserving network resources may include reserving an MPEG (Moving Picture Expert Group) channel for relaying the information from a local or regional headend 106, content source 104, or the like, to the user's STB 108.

According to the MPEG standard, channel data is packaged into data packets. Each data packet includes a packet identifier (PID). The PID indicates to a channel decoder within the STB 108 the channel to which the packet belongs.

MPEG allows for multiplexing a plurality of channels of video, audio, and other data in a single transmission. The receiving STB 108 examines the PID of each data packet to determine whether the user has indicated a desire to tune into that particular channel. While some of the MPEG channels may be assigned to particular television channels, other MPEG channels may be reserved for special purposes. Of these reserved MPEG channels, one or more may be reserved specifically for transmission of the retrieved information.

In one embodiment, reserving an MPEG channel includes designation of a channel at the headend 106 as a reserved channel. This may include updating a private information indexing table to indicate which PID will be used for sending the retrieved information to the STB 108. Private information indexing tables are well known in the video compression art.

Preferably, the STB 108 is notified as to how (and possibly when) the information will be sent. This is accomplished, in one embodiment, by sending the private information indexing table to the STB 108. When the table is received, both the sender of the information (e.g., the headend 106) and the receiver (e.g., the STB 108) know which channel will be used to transmit the information. In one embodiment, the STB 108 sets information retrieval triggers to review data packets received on the reserved MPEG channel in order to detect the information when it is received by the STB 108.

The present invention contemplates all forms of network communication including wireless, satellite, telephone, cable, and the like. The present invention also contemplates various protocols which allow communications between components of a particular network. Consequently, the present invention includes reservation of communications resources consistent with the particular physical communications medium and protocols being used.

After the delivery criteria have been satisfied upon receipt of a low-ink level signal by the printer monitoring component 1304, the information retrieval component 1308 retrieves the selected or default set of information from one or more information sources 104 and sends the retrieved information to the information delivery component 1310 for delivery to the appropriate STB 108. In some cases, the retrieved information may be presented by launching a web browser configured to display the information from a particular website. For example, the web browser may provide online shopping of a replacement cartridge for the user and allow the user to compare pricing and product information, and select the supplier, product, shipping, and the like.

In one embodiment, the retrieved information may be sent by a headend 106 or the like to an STB 108 in a single transmission. In some cases, however, a headend 106 may be configured to send a certain number of data packets in a particular sequence and then repeat the sequence. This looping through a set of data packets is known as a “carousel.” The set of data packets in a carousel may be modified over time.

In one embodiment, the information delivery component 1310 temporarily stores the retrieved information in a buffer or cache at a headend 106. Thereafter, the information is converted into MPEG data packets with a PID that corresponds to the reserved MPEG channel. Finally, the information delivery component 1310 sends the data packets to the STB 108 associated with the low-ink level signal using a single transmission or a carousel.

As an example, multiple users have printers that are being monitored for low-ink levels. Upon the detection by the printer monitoring component 1304 of a low-ink level signal from a printer associated with one of the STBs, the information retrieval component 1308 retrieves the cartridge information from one or more printer cartridge data sources 104 on the Internet 102 and then provides the cartridge information to the information delivery component 1310 for delivery to the corresponding STB 108 using one or more reserved MPEG channels.

As with the other components of the system 1300, the printer monitoring component 1304, the communication channel reservation component 1306, the information retrieval component 1308, and information delivery component 1310 may be implemented in software, hardware or firmware, within an STB 108, headend 106, information source 104, or other computer connected to the system 100.

In one embodiment, the information retrieval triggers in the STB 108 detect incoming data packets using the reserved channel. Once the data packets are detected, they are decoded by the STB 108 and delivered to the user notification component 1312 and the optional on-line shopping component 1314.

In one embodiment, the user notification component 1312 notifies the user of the delivered information using the requested or default notification format, as previously described. For example, the user notification component 1312 may display a reminder in a designated area of the UI, such as a personal reminder area. The on-line shopping component 1314 facilitates an order for the ink refill product, for instance, by launching an on-line shopping web browser, retrieving the user's wallet information, receiving order requests from the user through the communication device, and transmitting the order requests and wallet information to the supplier.

FIG. 15 is a flowchart of a method 1500 for information retrieval, delivery, and notification using a system of communication devices such as an Internet-enabled television system according to an embodiment of the invention. The method 1500 begins with the query 1501 by allowing the user to preselect the default settings or proceed to an optional customization step 1502 to preselect the information to be retrieved and delivered and a notification format.

Once the delivery criteria are satisfied by receipt of the low-ink level signal, a communication channel is reserved (step 1504) for delivery of the information, in which the STB 108 is informed as to how (e.g., on what MPEG channel) the information will be delivered. Thereafter, one or more information sources 104 are accessed (step 1506) and the retrieved information is delivered (step 1508) from the information source(s) 104 to the user's STB 108 using the reserved communication channel. Thereafter, the user is notified (step 1510) concerning the information using the requested or default notification format.

In one embodiment, the user has the option of ordering the ink refill product on-line (step 1512). For instance, the user is directed to an on-line shopping website that allows the user to obtain product, pricing, and shipping information and to make an on-line purchase. The user's wallet information including credit card information and shipping address may also be automatically retrieved for convenient and quick on-line purchases. The user will not need to look for and enter such data. The purchase of refill cartridges is user-friendly, quick, convenient, and easy. On-line shopping schemes are well known in the art.

While the printer ink refill notification features have been described above in the context of a system for distributing multimedia content to Internet-enable televisions or similar communication devices, it is understood that the invention can be employed for monitoring a printer for a personal computer or in a computer system such as a networked computer system. In a networked computer system, the printer(s) may be connected to the network server which will be the communication device that receives the low-ink level notification.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method of providing automatic prompting for printer ink refill of a printer connected to a communication device, the method comprising:
monitoring the printer for an ink refill signal; and
automatically delivering a user notification to a user of the communication device connected to the printer upon receiving the ink refill signal associated with the printer.

2. The method of claim 1, wherein the ink refill signal is generated by an ink level sensor of the printer upon sensing a low ink level.

3. The method of claim 1, further comprising identifying the printer model and ink refill product for the printer.

4. The method of claim 3, wherein the printer model is identified from the printer driver in the communication device.

5. The method of claim 3, wherein the ink refill product for the printer is identified by accessing an ink refill product identification source.

6. The method of claim 3, further comprising retrieving information for the ink refill product for the printer from an information source and delivering the retrieved information to the communication device connected to the printer.

7. The method of claim 6, wherein the retrieved information for the ink refill product comprises product, supplier, pricing, and shipping information.

8. The method of claim 7, wherein the retrieved information for the ink refill product comprises product, supplier, pricing, and shipping information from a plurality of suppliers.

9. The method of claim 7, further comprising facilitating an order for the ink refill product by a user via the communication device.

10. The method of claim 9, wherein facilitating comprises launching a web browser to provide on-line shopping to the user of the communication device.

11. The method of claim 7, further comprising retrieving wallet information associated with a user of the communication device connected to the printer.

12. The method of claim 6, wherein the information is delivered to the communication device by launching of a web browser configured to display the retrieved information from one or more websites.

13. The method of claim 6, wherein the information is delivered to the communication device using a default format.

14. The method of claim 6, wherein the information is delivered to the communication device using a format selected by a user of the communication device.

15. The method of claim 14, wherein the format is selected from the group consisting of alerts, always-active formats, button-press-required formats, and email notifications.

16. The method of claim 6, wherein the type of information to be delivered to the communication device is preselected by a user of the communication device.

17. The method of claim 1, wherein the communication device comprises an Internet-enabled television system.

18. The method of claim 17, wherein the Internet-enabled television system provides a graphical user interface, and wherein delivering the user notification comprises displaying the user notification in a designated area of the graphical user interface.

19. The method of claim 17, wherein delivering the user notification comprises superimposing the user notification over a television program displayed by the Internet-enabled television system.

20. The method of claim 19, wherein superimposing the user notification comprises horizontally scrolling the superimposed notification in a ticker format.

21. The method of claim 17, further comprising:
retrieving information of the ink refill product for the printer and delivering the delivered information to the communication device connected to the printer; and
displaying the retrieved information on the Internet-enabled television system in response to a subsequent user action.

22. The method of claim 17, wherein delivering a user notification comprises sending an e-mail message to a user of the communication device.

23. The method of claim 1, wherein the communication device comprises a computer device.

24. The method of claim 1, wherein the communication device comprises a network server in a computer network system.

25. A system of providing automatic prompting for printer ink refill of a printer connected to a communication device, the system comprising:
a printer monitoring component configured to monitor the printer for an ink refill signal; and
a user notification component within the communication device configured to automatically notify a user of the communication device in response to receipt of the ink refill signal.

26. The system of claim 25, further comprising an information retrieval component configured to retrieve ink refill information for the printer.

27. The system of claim 26, further comprising an information delivery component configured to deliver the retrieved information to the communication device in response to receipt of the ink refill signal.

28. The system of claim 27, further comprising a communication channel reservation component configured to reserve a communication channel for delivery of information to the communication device.

29. The system of claim 27, further comprising an on-line shopping component configured to facilitate on-line shopping of one or more ink refill products on the Internet.

30. The system of claim 27, further comprising a user customization component configured to receive a user selection of a notification format for delivery of the information.

31. The system of claim 25, wherein the communication device comprises an Internet-enable television system.

32. The system of claim 31, wherein the Internet-enabled television system provides a graphical user interface, and wherein the user notification component is further configured to display the information in a designated area of the graphical user interface.

33. The system of claim 31, wherein the user notification component is further configured to superimpose the information over a television program displayed by the Internet-enabled television system.

34. The system of claim 33, wherein the user notification component is further configured to horizontally scroll the superimposed information in a ticker format.

35. The system of claim 31, further comprising:
an information retrieval component configured to retrieve ink refill information for the printer; and
an information delivery component configured to deliver the retrieved information to the communication device in response to receipt of the ink refill signal,
wherein the user notification component is further configured to display a delivery notice on the Internet-enabled television system and displaying the retrieved information on the Internet-enabled television system in response to a subsequent user action.

36. The system of claim 31, wherein the user notification component is further configured to send an e-mail message to the user.

37. The system of claim 25 wherein the communication device comprises a computer device.

38. The system of claim 25 wherein the communication device comprises a network server in a computer network system.
